(19) United States
(12) Patent Application Publication
(10) Pub. No.: US 2026/0242985 A1
(43) Pub. Date: Aug. 20, 2026

(54) COMPOSITE FIBERS WITH DYNAMIC AND STATIC SENSING FUNCTIONS BASED ON THERMAL SHRINKAGE PROCESS AND RAPID PREPARATION METHOD

(71) Applicants: Taizhou University, Taizhou (CN); Ningbo Lingzhi Machinery Technology Co., LTD, Ningbo (CN)

(72) Inventors: Xiangdong Kong, Taizhou (CN); Berlin Dong, Ningbo (CN); Yijin Pei, Taizhou (CN); Dafei Hou, Taizhou (CN); Keliang Feng, Taizhou (CN); Kai Zhou, Taizhou (CN); Yudie Shentu, Taizhou (CN); Pengyuan Qiu, Taizhou (CN); Xiaohong Jia, Taizhou (CN)

(21) Appl. No.: 19/294,220

(22) Filed: Aug. 7, 2025

(30) Foreign Application Priority Data
Feb. 19, 2025 (CN) 202510182177.6

(51) Int. Cl. D01F 8/18; D01F 1/09; D02G 3/44

(52) U.S. Cl. CPC D01F 8/18; D01F 1/09; D02G 3/441

(57) ABSTRACT

Composite fibers with dynamic and static sensing functions based on a thermal shrinkage process and a rapid preparation method relate to the technical field of composite fibers with core-shell structures. The composite fibers have a core-shell structure including a fiber core layer, a piezoresistive layer, a second conductive layer, a piezoelectric layer, a first conductive layer and an insulating protection layer from inside to outside in sequence, or a metal core layer, the piezoelectric layer, the first conductive layer, the piezoresistive layer and the insulating protection layer from inside to outside in sequence; a coaxial multi-layer functional structure is composited, which integrates the dynamic (piezoelectric effect) and static (piezoresistive effect) sensing functions in a single fiber, thereby breaking through the sensing limitation of a traditional single material or a single physical effect fiber, and realizing synchronous detection of broadband (dynamic and static) force and motion signals.

### CROSS-REFERENCE TO RELATED APPLICATION

This application claims priority of Chinese Patent Application No. 202510182177.6, filed on Feb. 19, 2025, the entire contents of which are incorporated herein by reference.

### FIELD OF THE INVENTION

The present invention relates to the technical field of composite fibers with core-shell structures, and specifically relates to composite fibers with dynamic and static sensing functions based on a thermal shrinkage process and a rapid preparation method.

### BACKGROUND OF THE INVENTION

With the rapid development of smart wearable devices, flexible electronics, medical monitoring, and Internet of Things technologies, the demand for high-performance intelligent sensing materials is increasingly urgent. Smart fibers, as a flexible sensing unit that can be directly integrated into textiles, have become a research hotspot in the field of intelligent materials due to their lightweight, weavability, and good environmental adaptability. Traditional intelligent sensing fibers mainly provide resistance, capacitance, or piezoelectric response characteristics by embedding sensing materials (such as metal wires, carbon-based materials, or conductive polymers) into fiber substrates. However, existing technologies generally suffer from problems such as single-material systems, complex preparation processes, and insufficient dynamic response performance, which severely restricts their large-scale application.

In terms of material systems, the traditional sensing fibers often have metals (such as copper, silver, or shape memory alloys) as core conductive layers or sensing layers. The metal materials have good electrical conductivity and mechanical strength, but also have significant inherent defects like that: metal-core fibers are high in density and low in flexibility, are prone to plastic deformation or even fracture by repeated bending or stretching, resulting in decrease in sensing performance. Moreover, the metal materials have poor chemical stability and are prone to oxidation failure in humid or corrosive environments. In addition, the rigid characteristics of the metal fibers have poor mechanical compatibility with human skin or the flexible substrates, which limit the application in the wearable devices. In recent years, researchers have attempted to use nonmetal materials (such as carbon fibers and conductive polymers) to replace metals, but the single-material system often cannot balance the demands for high sensitivity, a wide range of sensing, and long-term stability.

In terms of preparation technology, existing intelligent fiber manufacturing methods often depend on complex processing devices and multi-step molding processes. For example, the most common method for manufacturing metal-core sensing fibers is a mold-melt thread pressing method, moreover, a dip-coating process is used for preparing metal-core piezoelectric fibers, a hydrothermal extrusion method is used for preparing piezoelectric fibers, and a coaxial electrospinning method is used for manufacturing a piezoelectric bending sensor for airflow velocity sensing, and an electric-wetting assisted dry-spinning method is used for producing the metal-core piezoelectric fibers. These methods not only consume a lot of energy and have long production cycles, but are also prone to performance fluctuations due to poor interlayer interface bonding. Moreover, traditional processes have strict requirements for thermal stability and rheological properties of materials, which limits the application expansion of novel functional materials. How to achieve rapid and low-cost preparation of high-performance composite fibers has become a technical bottleneck that it urgently to be broken through in the industry.

In terms of the sensing performance, the existing intelligent fibers are generally subjected to limitations in both dynamic and static sensing capabilities. Sensing fibers prepared from the single piezoresistive or piezoelectric materials often only respond to dynamic force signals (such as vibration and impact), while lacking sensitivity to static force (such as sustained pressure and deformation), or facing problem of signal drift. For example, piezoresistive fibers based on carbon nanotubes are prone to resistance baseline drift under static pressure due to creep effects; although the piezoelectric fibers (such as PVDF) are sensitive to dynamic strain but cannot capture static force information. Additionally, sensing signals of the traditional fibers are easily affected by environmental temperature and humidity, making long-term stability difficult to meet the needs of high-precision scenarios like medical monitoring or industrial testing. Therefore, developing composite fiber structures that integrate both dynamic and static sensing, broadband response, and resistance to environmental interference is the key to enhancing the practicality of the intelligent fibers.

In view of the above problems, some studies have attempted to optimize the sensing performance by material composites and structural design. For example, the patent CN114923604B proposes covering a metal wire surface with a piezoresistive/piezoelectric double-layer structure to expand the sensing range. However, the rigid characteristics of the metal core lead to decrease in flexibility of the fibers, and the interlayer interface is prone to peeling and failure after repeated deformation. In another study (Advanced Materials, 2021), a solution of embedding liquid metal into hollow fibers was carried out to improve flexibility, but the complex packaging process and risk of liquid metal leakage limit its industrialization process. Thus, in existing technology, it still have not effectively solved the problem of collaborative optimization of materials-structure-process, and there is an urgent need for a new solution that balances high performance, low cost, and ease of manufacturing.

In conclusion, there are three core challenges to the further development of the intelligent sensing fibers: 1, how to break through the limitations of the mechanical properties of the metal-core materials, and realize the unity of high strength, lightweight and flexibility by the innovation of the nonmetal materials; 2, how to simplify the preparation process of composite fibers and develop efficient molding technologies that do not require complex devices; and 3, how to achieve accurate perception of dynamic and static forces and improve signal stability by the coupling of multiple physical effects (such as piezoresistive-piezoelectric collaboration). The breakthrough of these technical bottlenecks will directly promote the large-scale application of the intelligent fibers in the wearable health monitoring, robot tactile sensing, smart textiles and other fields.

### SUMMARY OF THE INVENTION

In view of the shortages in related technology, an objective of the present invention is to provide composite fibers with dynamic and static sensing functions based on a thermal shrinkage process and a rapid preparation method.

In order to achieve the above object, the present invention provides the technical scheme as follows:

Composite fibers with dynamic and static sensing functions based on a thermal shrinkage process, having a core-shell structure comprising a metal core layer, a piezoelectric layer, a first conductive layer, a piezoresistive layer and an insulating protection layer from inside to outside in sequence, the piezoelectric layer is a piezoelectric heat shrink tubing which coats the outer surface of the metal core layer by thermal shrinkage; the first conductive layer is conductive paint/glue sprayed on the surface of the piezoelectric heat shrink tubing; the piezoresistive layer is a piezoresistive heat shrink tubing which coats the outer side of the first conductive layer by thermal shrinkage; and the insulating protection layer is an insulating heat shrink tubing which coats the outer side of the conductive paint/glue by thermal shrinkage.

Composite fibers with dynamic and static sensing functions based on a thermal shrinkage process, having a core-shell structure comprising a fiber core layer, a piezoelectric layer, a second conductive layer, a piezoresistive layer, a first conductive layer and an insulating protection layer from inside to outside in sequence, the piezoresistive layer is a piezoresistive heat shrink tubing which coats the outer side of the fiber core layer by thermal shrinkage; the second conductive layer is conductive paint/glue sprayed on the surface of the piezoresistive heat shrink tubing; the piezoelectric layer is a piezoelectric heat shrink tubing which coats the outer surface of the second conductive layer by thermal shrinkage; the first conductive layer is conductive paint/glue sprayed on the surface of the piezoelectric heat shrink tubing; and the insulating protection layer is an insulating heat shrink tubing which coats the outer side of the conductive paint/glue by thermal shrinkage.

The piezoelectric heat shrink tubing is any one selected from the group of a PVDF tubing, an odd nylon tubing or an aromatic polyurea tubing.

The insulating heat shrink tubing is any one selected from the group of an EPDM heat shrink tubing, a crosslinked PEEK heat shrink tubing, a polytetrafluoroethylene (PTFE) heat shrink tubing and a silicone rubber heat shrink tubing.

The piezoresistive heat shrink tubing is any one selected from the group of a polyaniline conductive polymer tubing, a polypyrrole conductive polymer tubing, a crosslinked PA66 tubing and a metal-based composite tubing.

The metal core layer is a solid core or a hollow core prepared from metal.

The fiber core layer is a solid core or a hollow core prepared from nonmetal.

A rapid preparation method for preparing the composite fibers with dynamic and static sensing functions based on the thermal shrinkage process, comprising the following steps:
step 1: sleeving the metal core layer with the piezoelectric heat shrink tubing, and selecting the piezoelectric heat shrink tubing matched with the metal core layer according to the shrinkage ratio of the piezoelectric heat shrink tubing;
step 2: sleeving the outer side of the metal core layer with the piezoelectric heat shrink tubing, setting the temperature of a heat gun according to the thermal shrinkage temperature of the piezoelectric heat shrink tubing (the optimal temperature for the PVDF heat shrink tubing is usually 150° C.-175° C.), and thermally shrinking the piezoelectric heat shrink tubing on the outer surface of the metal core layer at a transverse scanning rate of 10-15 cm/s within a range of 5-10 cm away from the piezoelectric heat shrink tubing in a seamless tight fitting way, so as to obtain piezoelectric fibers;
step 3: putting the piezoelectric fibers prepared in step 2 into a heating furnace for a heating procedure, and setting the temperature rise rate of the heating furnace to be 1° C.-5 ° C. per minute to ensure uniform and consistent thermal shrinkage on the whole cross section of the piezoelectric heat shrink tubing;
step 4: after naturally cooling the piezoelectric heat shrink tubing in step 3 to room temperature, uniformly coating the surface of the piezoelectric heat shrink tubing with a conductive film layer as the first conductive layer;
step 5: selecting the piezoresistive heat shrink tubing matched with the thermally shrunk piezoelectric heat shrink tubing on the basis of the shrinkage ratio of the piezoresistive heat shrink tubing;
step 6: sleeving the outer side of the first conductive layer with the piezoresistive heat shrink tubing, setting the temperature of the heat gun according to the thermal shrinkage temperature of the piezoresistive heat shrink tubing (the optimal temperature for the crosslinked PA66 heat shrink tubing is usually 80° C.-150°C.), and thermally shrinking the piezoresistive heat shrink tubing on the outer surface of the heat shrink tubing at a transverse scanning rate of 10-15 cm/s within a range of 5-10 cm away from the piezoresistive heat shrink tubing in a seamless tight fitting way, so as to obtain a piezoelectric-piezoresistive heat shrink tubing;
step 7: putting the piezoelectric-piezoresistive heat shrink tubing prepared in step 6 into the heating furnace for the heating procedure, and setting the temperature rise speed of the heating furnace to ensure uniform and consistent thermal shrinkage on the whole cross section of the piezoresistive heat shrink tubing;
step 8: after naturally cooling the piezoresistive heat shrink tubing in step 7 to room temperature, sleeving the piezoresistive heat shrink tubing with the insulating heat shrink tubing, and selecting the insulating heat shrink tubing matched with the thermally shrunk piezoresistive heat shrink tubing on the basis of the shrinkage ratio of the insulating heat shrink tubing;
step 9: sleeving the outer side of the piezoresistive heat shrink tubing with the insulating heat shrink tubing, setting the temperature of the heat gun according to the thermal shrinkage temperature of the insulating heat shrink tubing (the optimal temperature for the EPDM heat shrink tubing is usually 135° C.-150° C.), and thermally shrinking the insulating heat shrink tubing on the outer surface of a piezoresistive layer at a transverse scanning rate of 10-15 cm/s within a range of 5-10 cm away from the insulating heat shrink tubing in a seamless tight fitting way, so as to obtain metal-core piezoelectric-piezoresistive composite fibers;
step 10: putting the metal-core piezoelectric-piezoresistive composite fibers prepared in step 9 into the heating furnace for the heating procedure, and setting the temperature rise speed of the heating furnace to be 1° C.-3 ° C. per minute to ensure uniform and consistent thermal shrinkage on the whole cross section of the metal-core piezoelectric-piezoresistive composite fibers; and
step 11: after naturally cooling to room temperature, taking out the metal-core piezoelectric-piezoresistive composite fibers in step 10 to finish preparation.

A rapid preparation method for preparing the composite fibers with dynamic and static sensing functions based on the thermal shrinkage process, comprising the following steps:
step 1: sleeving the fiber core layer with the piezoresistive heat shrink tubing, selecting the piezoresistive heat shrink tubing matched with the fiber core layer according to the shrinkage ratio of the piezoresistive heat shrink tubing;
step 2: sleeving the outer side of the fiber core layer with the piezoresistive heat shrink tubing, setting the temperature of the heat gun according to the thermal shrinkage temperature of the piezoresistive heat shrink tubing (the optimal temperature for the crosslinked PA66 heat shrink tubing is usually 80° C.-150°C.), and thermally shrinking the piezoresistive heat shrink tubing on the outer surface of the fiber core layer at a transverse scanning rate of 10-15 cm/s in a range of 5-10 cm away from the piezoresistive heat shrink tubing in a seamless tight fitting way;
step 3: putting the piezoresistive heat shrink tubing prepared in step 2 into the heating furnace for a secondary heating procedure, and setting the temperature rise rate of the heating furnace to ensure uniform and consistent thermal shrinkage on the whole cross section of the piezoelectric heat shrink tubing;
step 4: after naturally cooling the piezoresistive heat shrink tubing in step 3 to room temperature, uniformly coating the surface of the piezoresistive heat shrink tubing with a conductive film layer as the second conductive layer;
step 5: sleeving the piezoresistive heat shrink tubing processed in step 4 with the piezoelectric heat shrink tubing, and selecting the piezoelectric heat shrink tubing matched with the piezoresistive heat shrink tubing according to the shrinkage ratio of the piezoelectric heat shrink tubing;
step 6: sleeving the outer side of the second conductive layer with the piezoelectric heat shrink tubing, setting the temperature of a heat gun according to the thermal shrinkage temperature of the piezoelectric heat shrink tubing (the optimal temperature for the PVDF heat shrink tubing is usually 150° C.-175° C.), and thermally shrinking the piezoelectric heat shrink tubing on the outer surface of the second conductive layer at the transverse scanning rate of 10-15 cm/s within a range of 5-10cm away from the piezoelectric heat shrink tubing in a seamless tight fitting way, so as to obtain a piezoresistive-piezoelectric heat shrink tubing;
step 7: putting the piezoresistive-piezoelectric heat shrink tubing prepared in step 6 into the heating furnace for the heating procedure, and setting the temperature rise rate of the heating furnace to be 1° C.-5 ° C. per minute to ensure uniform and consistent thermal shrinkage on the whole cross section of the piezoresistive-piezoelectric heat shrink tubing;
step 8: after naturally cooling the piezoresistive-piezoelectric heat shrink tubing in step 7 to room temperature, uniformly coating the surface of the piezoresistive-piezoelectric heat shrink tubing with a conductive film layer as the first conductive layer;
step 9: sleeving the piezoresistive-piezoelectric heat shrink tubing prepared in step 8 with the insulating heat shrink tubing, and selecting the insulating heat shrink tubing matched with the piezoresistive-piezoelectric heat shrink tubing according to the shrinkage ratio of the insulating heat shrink tubing;
step 10: sleeving the outer side of the piezoresistive-piezoelectric heat shrink tubing with the insulating heat shrink tubing, setting the temperature of the heat gun according to the thermal shrinkage temperature of the insulating heat shrink tubing (the optimal temperature for the EPDM heat shrink tubing is usually 135°C.-150° C.) , and thermally shrinking the insulating heat shrink tubing on the outer surface of the first conductive layer at the transverse scanning rate of 10-15 cm/s within a range of 5-10 cm away from the insulating heat shrink tubing in a seamless tight fitting way, so as to obtain nonmetal-core piezoresistive-piezoelectric composite fibers;
step 11: putting the nonmetal-core piezoresistive-piezoelectric composite fibers prepared in step 10 into the heating furnace for the heating procedure, and setting the temperature rise rate of the heating furnace to be 1° C.- 3° C. per minute to ensure uniform and consistent thermal shrinkage on the whole cross section of the nonmetal-core piezoresistive-piezoelectric composite fibers; and
step 12: after naturally cooling the nonmetal-core piezoresistive-piezoelectric composite fibers in step 11 to room temperature, taking out the nonmetal-core piezoresistive-piezoelectric composite fibers to finish preparation.

The present invention has the beneficial effects that:
a coaxial multi-layer functional structure is composited, which integrates the dynamic (piezoelectric effect) and static (piezoresistive effect) sensing functions in a single fiber, thereby breaking through the sensing limitation of a traditional single material or a single physical effect fiber, and realizing synchronous detection of broadband (dynamic and static) force and motion signals.

The signal stability is optimized, the electric signal transmission efficiency is enhanced by the collaborative design of a conductive layer and a piezoresistive/piezoelectric layer, the environmental interference is reduced, and moreover, the durability and the environmental erosion resistance of the fibers are improved by an insulating protection layer.

An interlayer combination technology needing complex devices is avoided, a core layer substrate is directly sleeved with a thermal shrinkage functional tubing (piezoresistive, piezoelectric and insulating tubing), and tight fitting between all functional layers is realized by the thermal shrinkage process; and therefore, traditional complex processes such as multilayer melt co-extrusion, chemical deposition or vacuum coating are avoided, and the device dependence and the manufacturing cost are greatly reduced. A conductive path is rapidly constructed by a spraying process, thus the process steps are simplified, the production efficiency is improved, and it is suitable for large-scale production.

A piezoresistive-piezoelectric dual-mode sensing mechanism is adopted, the piezoresistive layer (such as polyaniline, polypyrrole and other conductive polymer tubing, a crosslinked PA66 tubing and a metal-based composite tubing) senses static pressure and deformation by resistance change, the piezoelectric layer (such as a PVDF tubing, an odd nylon tubing or an aromatic polyurea tubing) captures dynamic vibration and instantaneous impact by charge output, and therefore, the sensing range and sensitivity are remarkably expanded by dual-mode coordination.

High-performance nonmetal materials such as Kevlar, PEEK, and PA66 are adopted to replace traditional metals (like copper and silver) as the fiber core layer to significantly improve the tensile strength, flexibility, wear resistance, and fatigue properties of the fibers, while also reducing the weight of the fibers, and solving the problems of metal-core fibers, such as high density, susceptibility to oxidation and breakage, and poor compatibility with flexible substrates. It supports solid or hollow core layer design, a hollow structure can further reduce weight or integrate other functional materials (such as fluid sensing media), thereby expanding application scenarios.

### BRIEF DESCRIPTION OF THE DRAWINGS

FIG. 1 is a flowchart of specific preparation in an Embodiment 1 of the present invention;

FIG. 2 is a schematic structural diagram of metal-core piezoelectric-piezoresistive composite fibers;

FIG. 3 shows test results of sensing voltage of metal-core piezoelectric-piezoresistive composite fibers at different pressure according to the present invention;

FIG. 4 is a flowchart of specific preparation in an Embodiment 2 of the present invention;

FIG. 5a is a schematic structural diagram of nonmetal-core piezoelectric-piezoresistive composite fibers, in which, a is a schematic diagram of a solid section of nonmetal-core coaxial composite piezoresistive-piezoelectric fibers;

FIG. 5b is a schematic diagram of a hollow section of nonmetal-core coaxial composite piezoresistive-piezoelectric fibers;

FIG. 5c is a section schematic diagram of combining a nonmetal-core layer and a piezoelectric layer into nonmetal-core coaxial composite piezoresistive-piezoelectric fibers;

FIG. 5d is a section schematic diagram of nonmetal-core coaxial composite piezoelectric fibers;

FIG. 5e is a section schematic diagram of nonmetal-core coaxial composite piezoresistive fibers;

FIG. 6 shows a measured stress-strain comparison curve of sensing composite fibers prepared from a metal copper core and a non-metal Kevlar core; and

FIG. 7 is a curve chart of force-resistance relationship test of non-metal piezoelectric-piezoresistive composite fibers PA66 with surfaces coated with conductive silver lacquer piezoresistive fibers.

### DETAILED DESCRIPTION OF SOME EMBODIMENTS

The technical solutions in the embodiments of the present invention will be clearly and completely described as follows in combination with the drawings in the examples of the present invention, but obviously, the described examples are only a part of the embodiments of the present invention, rather than all the embodiments. Based on the examples of the present invention, all other examples obtained by a person skilled in the art without creative efforts shall fall within the protection scope of the present invention.

### Embodiment 1

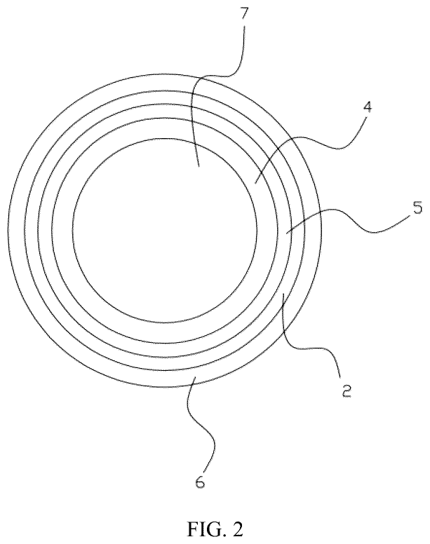

As shown in FIG. 2, the present invention discloses metal-core piezoelectric-piezoresistive composite fibers, which have a core-shell structure including a metal core layer 7, a piezoelectric layer 4, a first conductive layer 5, a piezoresistive layer 2 and an insulating protection layer 6 from inside to outside in sequence; the piezoelectric layer 4 is a piezoelectric heat shrink tubing which coats the outer surface of the metal core layer 7 by thermal shrinkage; the first conductive layer 5 is conductive paint/glue sprayed on the surface of the piezoelectric heat shrink tubing; the piezoresistive layer 2 is a piezoresistive heat shrink tubing which coats the outer side of the first conductive layer 5 by thermal shrinkage; and the insulating protection layer is an insulating heat shrink tubing which coats the outer side of the conductive paint/glue by thermal shrinkage. The piezoelectric layer 4 is any one selected from the group of a PVDF tubing, an odd nylon tubing or aromatic polyurea tubing which coats the outer surface of the conductive layer by thermal shrinkage; the first conductive layer is any one selected from the group of conductive silver lacquer, epoxy conductive glue, polyurethane conductive glue and anisotropic conductive glue; the insulating protection layer is an insulating heat shrink tubing which coats the outer side of the conductive layer by thermal shrinkage, such as an EPDM heat shrink tubing, a crosslinked PEEK heat shrink tubing, a polytetrafluoroethylene (PTFE) heat shrink tubing and a silicone rubber heat shrink tubing; and the piezoresistive layer is any one selected from the group of a piezoresistive material which coats the outer surface of the fiber core layer by thermal shrinkage, such as polyaniline, polypyrrole and other conductive polymer tubing, a crosslinked PA66 tubing, and a metal-based composite tubing.

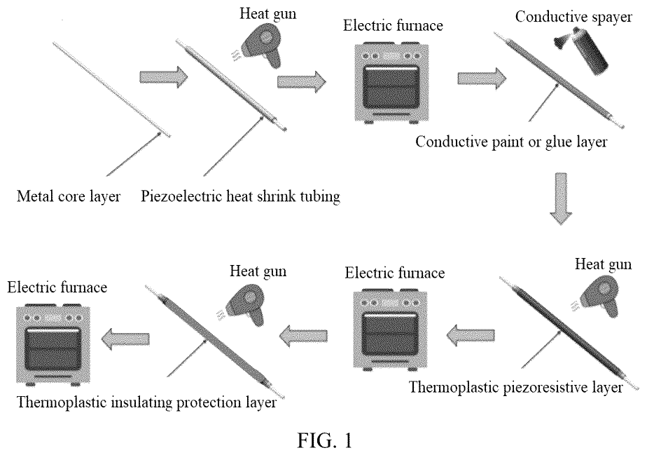

As shown in FIG. 1, the present invention further discloses a rapid preparation method for preparing the above composite fibers with the dynamic and static sensing functions based on the thermal shrinkage process, which includes the following steps:
step 1: sleeving a metal copper core with the PVDF heat shrink tubing, and selecting the PVDF heat shrink tubing matched with the metal core on the basis of a shrinkage ratio range of the PVDF heat shrink tubing of 2:1 to 3:1;
step 2: sleeving the outer side of the metal core layer with the PVDF tubing, setting the temperature of a heat gun according to the thermal shrinkage temperature of the piezoelectric heat shrink tubing (the optimal temperature for the PVDF heat shrink tubing is usually 150° C.-175° C.), and thermally shrinking a piezoelectric tubing on the outer surface of the metal core at a transverse scanning rate of 10-15 cm/s within a range of 5-10 cm away from the piezoelectric tubing in a seamless tight fitting way;
step 3: putting the piezoelectric fibers prepared in step 2 into a heating furnace for a heating procedure, and setting the temperature rise rate of the heating furnace to be 1° C.- 5 ° C. per minute to ensure uniform and consistent thermal shrinkage on the whole cross section of the piezoelectric heat shrink tubing;
step 4: after naturally cooling the piezoelectric heat shrink tubing in step 3 to room temperature, uniformly coating the surface of the piezoelectric heat shrink tubing with a layer of conductive silver lacquer;
step 5: selecting the piezoresistive heat shrink tubing matched with the thermally shrunk piezoelectric heat shrink tubing on the basis of the shrinkage ratio range of the crosslinked PA66 heat shrink tubing of 2:1 to 4:1;
step 6: sleeving the outer side of the piezoelectric layer with the crosslinked PA66 heat shrink tubing, setting the temperature of the heat gun according to the thermal shrinkage temperature of the piezoresistive heat shrink tubing (the optimal temperature for the crosslinked PA66 heat shrink tubing is usually 80° C.-150°C.), and thermally shrinking the piezoresistive heat shrink tubing on the outer surface of the piezoelectric heat shrink tubing at a transverse scanning rate of 10-15 cm/s within a range of 5-10 cm away from the piezoresistive heat shrink tubing in a seamless tight fitting way;
step 7: putting the piezoelectric-piezoresistive heat shrink tubing prepared in step 6 into the heating furnace for the heating procedure, and setting the temperature rise speed of the heating furnace as: 5° C.-20 ° C. per minute by a small-size heating furnace, and 1° C.-5 ° C. per minute by a large-size industrial heating furnace, so as to ensure uniform and consistent thermal shrinkage on the whole cross section of the crosslinked PA66 heat shrink tubing;
step 8: after naturally cooling the piezoresistive heat shrink tubing in step 7 to room temperature, sleeving the piezoresistive heat shrink tubing with the insulating heat shrink tubing, and selecting the insulating heat shrink tubing matched with the thermally shrunk piezoresistive heat shrink tubing on the basis of the shrinkage ratio range of the insulating heat shrink tubing of 2:1;
step 9: sleeving the outer side of the piezoresistive heat shrink tubing with the insulating heat shrink tubing, setting the temperature of the heat gun according to the thermal shrinkage temperature of the insulating heat shrink tubing (the optimal temperature for the EPDM heat shrink tubing is usually 135° C.-150° C.), and thermally shrinking the insulating heat shrink tubing on the outer surface of a piezoresistive layer at a transverse scanning rate of 10-15 cm/s within a range of 5-10 cm away from the insulating heat shrink tubing in a seamless tight fitting way;
step 10: putting the metal-core piezoelectric-piezoresistive composite fibers prepared in step 9 into the heating furnace for the heating procedure, and setting the temperature rise speed of the heating furnace to be 1° C.-3 ° C. per minute, so as to ensure uniform and consistent thermal shrinkage on the whole cross section of the metal-core piezoelectric-piezoresistive composite fibers; and
step 11: after naturally cooling to the room temperature, taking out the piezoelectric-piezoresistive composite fibers in step 10 to finish preparation.

The preparation process can also be used for simplifying the preparation of the metal-core piezoelectric composite fibers or the metal-core piezoresistive composite fibers according to actual requirements.

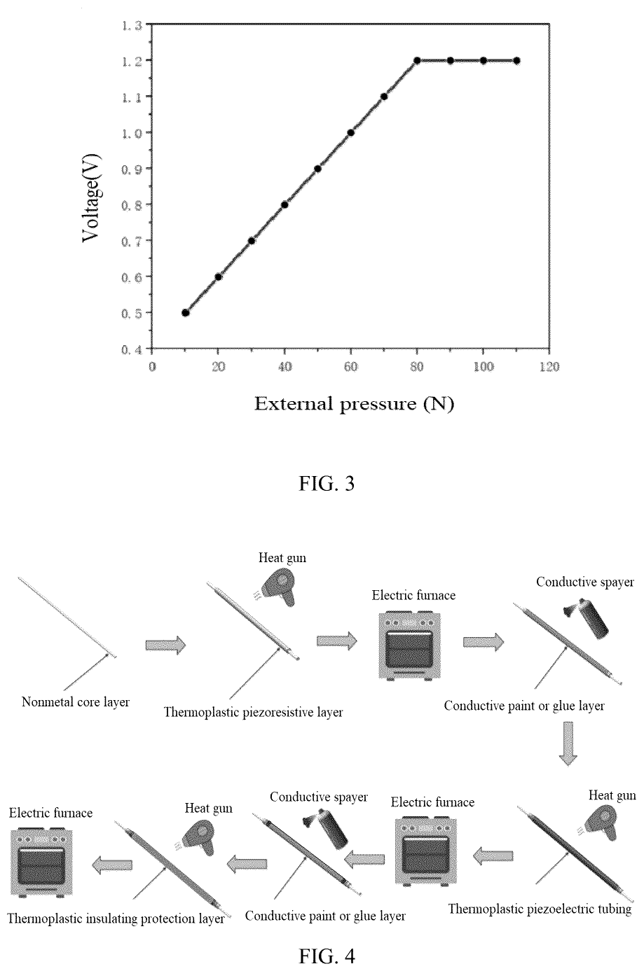

As shown in FIG. 3, the test results of sensing voltage at different pressure by the metal-copper-core PVDF piezoelectric composite fibers prepared by the above method (tested 10 times with the same pressure at the same position) are used in test of the piezoelectric memory function and pressure sensing performance of the PVDF piezoelectric heat shrink tubing after thermal shrinkage, and the results show that metal-core thermoplastic piezoelectric fibers prepared by the thermal shrinkage method have good piezoelectric performance, and the pressure and the piezoelectric sensing are in a linear relationship in a certain range.

### Embodiment 2

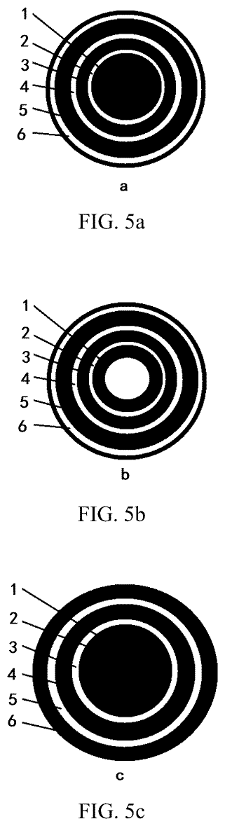

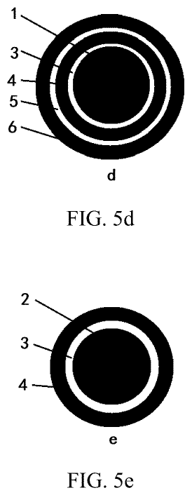

As shown in FIGS. 5a-5e, the present invention discloses non-metal-core piezoelectric composite fibers, which have a core-shell structure including a fiber core layer 1 (nonmetal-core layer), a piezoresistive layer 2, a conductive layer 3, a piezoelectric layer 4, a first conductive layer 5 and an insulating protection layer 6 from inside to outside in sequence; the fiber core layer is a solid core or a hollow core prepared from nonmetal (Kevlar or PEEK or PA66 or carbon nanotubes, etc.), a piezoresistive layer is a piezoresistive material which coats the outer surface of the fiber core layer by thermal shrinkage, such as polyaniline, polypyrrole and other conductive polymer tubing, a crosslinked PA66 tubing, and a metal-based composite tubing; the conductive layer and the first conductive layer are conductive paint or glue (conductive silver lacquer, epoxy conductive glue, polyurethane conductive glue, anisotropic conductive glue, etc.) sprayed on the surface of the piezoresistive layer; the piezoelectric layer is a PVDF tubing or an odd nylon tubing or an aromatic polyurea tubing which coats the outer surface of the conductive layer by thermal shrinkage; and the insulating protection layer is an insulating heat shrink tubing which coats the outer side of the conductive layer by thermal shrinkage, such as an EPDM heat shrink tubing, a crosslinked PTFE heat shrink tubing, a polytetrafluoroethylene (PEEK) heat shrink tubing, and a silicone rubber heat shrink tubing.

High-performance nonmetal materials such as Kevlar, PEEK, and PA66 are adopted to replace traditional metals (like copper and silver) as the fiber core layer to significantly improve the tensile strength, flexibility, wear resistance, and fatigue properties of the fibers, while also reducing the weight of the fibers, and solving the problems of metal-core fibers, such as high density, susceptibility to oxidation and breakage, and poor compatibility with flexible substrates. It supports solid or hollow core layer design, a hollow structure can further reduce weight or integrate other functional materials (such as fluid sensing media), thereby expanding application scenarios.

As shown in FIG. 4, the present invention further provides a rapid preparation method for preparing the above composite fibers with the dynamic and static sensing functions based on the thermal shrinkage process, which includes the following steps:
step 1: sleeving the fiber core layer with the piezoresistive heat shrink tubing, selecting the piezoresistive heat shrink tubing matched with the fiber core layer according to the shrinkage ratio of the piezoresistive heat shrink tubing, and treating the crosslinked PA66 heat shrink tubing as the piezoresistive heat shrink tubing, in which, the shrinkage ratio range is 2:1 to 4:1;
step 2: sleeving the outer side of the fiber core layer with the piezoresistive heat shrink tubing, setting the temperature of the heat gun according to the thermal shrinkage temperature of the piezoresistive heat shrink tubing (the optimal temperature for the crosslinked PA66 heat shrink tubing is usually 80° C.-150°C.), and thermally shrinking the piezoresistive heat shrink tubing on the outer surface of the fiber core layer at a transverse scanning rate of 10-15 cm/s in a range of 5-10 cm away from the piezoresistive heat shrink tubing in a seamless tight fitting way;
step 3: putting the piezoresistive heat shrink tubing prepared in step 2 into the heating furnace for a secondary heating procedure, and setting the temperature rise rate of the heating furnace as: 5° C.-20 ° C. per minute by a small-size heating furnace, and 1° C.- 5° C. per minute by a large-size industrial heating furnace, so as to ensure uniform and consistent thermal shrinkage on the whole cross section of the piezoresistive heat shrink tubing;
step 4: after naturally cooling the piezoresistive heat shrink tubing in step 3 to room temperature, uniformly coating the surface of the piezoresistive heat shrink tubing with a conductive film layer as the second conductive layer;
step 5: sleeving the piezoresistive heat shrink tubing prepared in step 4 with the piezoelectric heat shrink tubing, selecting the piezoelectric heat shrink tubing matched with the piezoresistive heat shrink tubing according to the shrinkage ratio of the piezoelectric heat shrink tubing, treating the PVDF tubing as the piezoelectric heat shrink tubing, and selecting the PVDF tubing matched with the piezoresistive heat shrink tubing on the basis of the shrinkage ratio range of the PVDF tubing being 2:1 to 3:1;
step 6: sleeving the outer side of the second conductive layer with the piezoelectric heat shrink tubing, setting the temperature of a heat gun according to the thermal shrinkage temperature of the piezoelectric heat shrink tubing (the optimal temperature for the PVDF heat shrink tubing is usually 150° C.-175° C.), and thermally shrinking the piezoelectric heat shrink tubing on the outer surface of the piezoresistive layer at the transverse scanning rate of 10-15 cm/s within a range of 5-10 cm away from the piezoelectric heat shrink tubing in a seamless tight fitting way, so as to obtain the piezoresistive-piezoelectric heat shrink tubing;
step 7: putting the piezoresistive-piezoelectric heat shrink tubing prepared in step 6 into the heating furnace for the heating procedure, and setting the temperature rise rate of the heating furnace to be 1° C.- 5 ° C. per minute to ensure uniform and consistent thermal shrinkage on the whole cross section of the piezoresistive-piezoelectric heat shrink tubing;
step 8: after naturally cooling the piezoresistive-piezoelectric heat shrink tubing in step 7 to room temperature, uniformly coating the surface of the piezoresistive-piezoelectric heat shrink tubing with a conductive film layer as the first conductive layer;
step 9: sleeving the piezoresistive-piezoelectric heat shrink tubing prepared in step 8 with the insulating heat shrink tubing, and selecting the insulating heat shrink tubing matched with the piezoresistive-piezoelectric heat shrink tubing according to the shrinkage ratio of the insulating heat shrink tubing;
step 10: sleeving the outer side of the piezoresistive-piezoelectric heat shrink tubing with the insulating heat shrink tubing, setting the temperature of the heat gun according to the thermal shrinkage temperature of the insulating heat shrink tubing (the optimal temperature for the EPDM heat shrink tubing is usually 135°C.-150° C.) , and thermally shrinking the insulating heat shrink tubing on the outer surface of the first conductive layer at the transverse scanning rate of 10-15 cm/s within a range of 5-10 cm away from the insulating heat shrink tubing in a seamless tight fitting way, so as to obtain the piezoresistive-piezoelectric composite fibers;
step 11: putting the piezoresistive-piezoelectric composite fiber prepared in step 10 into the heating furnace for heating procedure, and setting the temperature rise rate of the heating furnace to be 1° C.-3° C. per minute to ensure uniform and consistent thermal shrinkage on the whole cross section of the piezoresistive-piezoelectric composite fibers; and
step 12: after naturally cooling the piezoresistive-piezoelectric composite fibers in the step 11 to the room temperature, taking out the piezoresistive-piezoelectric composite fibers to finish manufacturing.

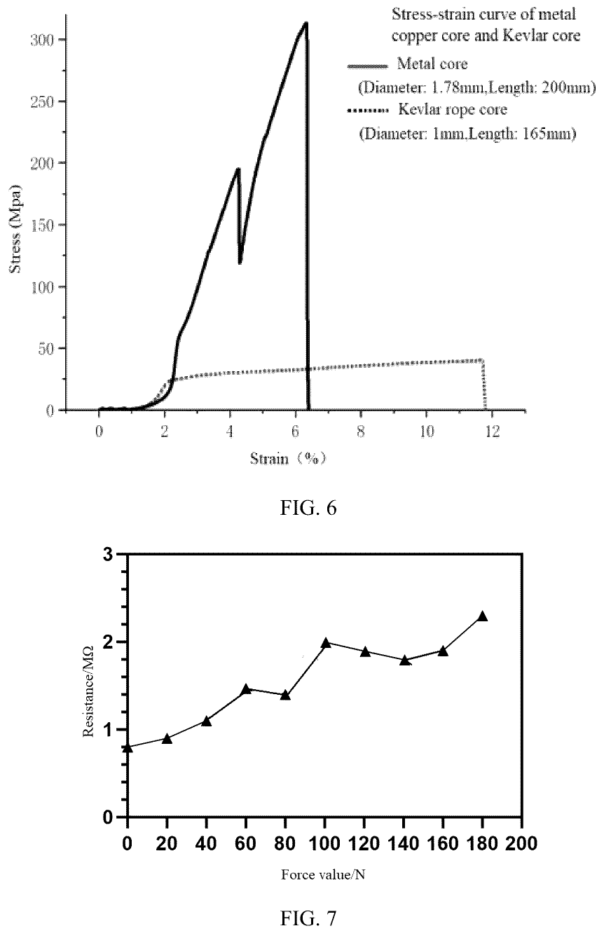

FIG. 6 shows a measured stress-strain comparison curve of sensing composite fibers prepared from a metal copper core and a non-metal Kevlar core, and an experimental result shows that after replacing the composite fibers with the metal copper cores by the Kevlar fibers, the tensile strength (in this test, the tensile strength of Kevlar-core composite fibers is 6 times that of the metal-copper-core composite fibers), the flexibility and the anti-fatigue property of the fibers can be remarkably improved by replacing, and moreover, the specific strength of the Kevlar fibers is 5 times that of a steel wire, and the density is only ⅙ that of copper, so that the weight of the composite fibers is greatly reduced. In the present invention, the nonmetal-core sensing composite fibers solve the problems that the metal-core sensing fibers have high density, susceptibility to oxidation and breakage, and poor compatibility with flexible substrates.

FIG. 7 is a curve chart of force-resistance relationship test of non-metal piezoelectric-piezoresistive composite fibers PA66 with surfaces coated with conductive silver lacquer piezoresistive fibers, which shows that the piezoresistive fibers prepared by the thermal shrinkage process in the present invention have good piezoresistive performance, and the pressure and the piezoresistive sensing are in a linear relationship in a certain range.

It supports to flexibly select the nonmetal core layer to meet different application requirements (such as high elasticity, ultra-light or high-strength scenarios), and moreover, the thermal shrinkage process has low requirements on the thermal stability of materials and can be compatible with more functional materials. The interface bonding degree is enhanced; and in the thermal shrinkage process, interlayer bonding is achieved by physical shrinkage instead of chemical bonding, so that the interface stripping risk in a traditional process is avoided, and the structural reliability of the fibers under repeated deformation is improved.

In conclusion, in the present invention, by deep integration of material innovation (nonmetal core layer), structural innovation (coaxial multifunctional layer), and process innovation (thermal shrinkage rapid molding), the composite fibers break through the bottlenecks of traditional smart fibers in mechanical performance, sensing dimensions, manufacturing costs, and environmental adaptability, and provide high-performance, low-cost sensing fiber solutions in the fields such as smart wearables, robotic touch, and health monitoring.

The embodiments shall not be regarded as a limitation of the present invention, but any improvement based on the spirit of the present invention shall be within the scope of protection of the present invention.

1. Composite fibers with dynamic and static sensing functions based on a thermal shrinkage process, having a core-shell structure comprising a metal core layer (7), a piezoelectric layer (4), a first conductive layer (5), a piezoresistive layer (2) and an insulating protection layer (6) from inside to outside in sequence, wherein the piezoelectric layer (4) is a piezoelectric heat shrink tubing which coats the outer surface of the metal core layer (7) by thermal shrinkage; the first conductive layer (5) is conductive paint/glue sprayed on the surface of the piezoelectric heat shrink tubing; the piezoresistive layer (2) is a piezoresistive heat shrink tubing which coats the outer side of the first conductive layer (5) by thermal shrinkage; and the insulating protection layer (6) is an insulating heat shrink tubing which coats the outer side of the conductive paint/glue by thermal shrinkage.

2. The composite fibers with dynamic and static sensing functions based on the thermal shrinkage process according to claim 1, wherein the piezoelectric heat shrink tubing is any one selected from the group of a PVDF tubing, an odd nylon tubing or an aromatic polyurea tubing.

3. The composite fibers with dynamic and static sensing functions based on the thermal shrinkage process according to claim 1, wherein the insulating heat shrink tubing is any one selected from the group of an EPDM heat shrink tubing, a crosslinked PEEK heat shrink tubing, a polytetrafluoroethylene (PTFE) heat shrink tubing and a silicone rubber heat shrink tubing.

4. The composite fibers with dynamic and static sensing functions based on the thermal shrinkage process according to claim 1, wherein the piezoresistive heat shrink tubing is any one selected from the group of a polyaniline conductive polymer tubing, a polypyrrole conductive polymer tubing, a crosslinked PA66 tubing and a metal-based composite tubing.

5. The composite fibers with dynamic and static sensing functions based on the thermal shrinkage process according to claim 1, wherein the metal core layer (7) is a solid core or a hollow core prepared from metal.

6. Composite fibers with dynamic and static sensing functions based on a thermal shrinkage process, having a core-shell structure comprising a fiber core layer (1), a piezoelectric layer (2), a second conductive layer (3), a piezoresistive layer (4), a first conductive layer (5) and an insulating protection layer (6) from inside to outside in sequence, wherein the piezoresistive layer (2) is a piezoresistive heat shrink tubing which coats the outer side of the fiber core layer (1) by thermal shrinkage; the second conductive layer (3) is conductive paint/glue sprayed on the surface of the piezoresistive heat shrink tubing; the piezoelectric layer (2) is a piezoelectric heat shrink tubing which coats the outer surface of the second conductive layer (5) by thermal shrinkage; the first conductive layer (5) is conductive paint/glue sprayed on the surface of the piezoelectric heat shrink tubing; and the insulating protection layer (6) is an insulating heat shrink tubing which coats the outer side of the conductive paint/glue by thermal shrinkage.

7. The composite fibers with dynamic and static sensing functions based on the thermal shrinkage process according to claim 6, wherein the piezoelectric heat shrink tubing is any one selected from the group of a PVDF tubing, an odd nylon tubing or an aromatic polyurea tubing.

8. The composite fibers with dynamic and static sensing functions based on the thermal shrinkage process according to claim 6, wherein the insulating heat shrink tubing is any one selected from the group of an EPDM heat shrink tubing, a crosslinked PEEK heat shrink tubing, a polytetrafluoroethylene (PTFE) heat shrink tubing and a silicone rubber heat shrink tubing.

9. The composite fibers with dynamic and static sensing functions based on the thermal shrinkage process according to claim 6, wherein the piezoresistive heat shrink tubing is any one selected from the group of a polyaniline conductive polymer tubing, a polypyrrole conductive polymer tubing, a crosslinked PA66 tubing and a metal-based composite tubing.

10. The composite fibers with dynamic and static sensing functions based on the thermal shrinkage process according to claim 6, wherein the fiber core layer (1) is a solid core or a hollow core prepared from nonmetal.

11. A rapid preparation method for preparing the composite fibers with dynamic and static sensing functions based on the thermal shrinkage process according to claim 1, comprising the following steps:
step 1: sleeving the metal core layer (7) with the piezoelectric heat shrink tubing, and selecting the piezoelectric heat shrink tubing matched with the metal core layer (7) according to the shrinkage ratio of the piezoelectric heat shrink tubing;
step 2: sleeving the outer side of the metal core layer (7) with the piezoelectric heat shrink tubing, setting the temperature of a heat gun according to the thermal shrinkage temperature of the piezoelectric heat shrink tubing (the optimal temperature for the PVDF heat shrink tubing is usually 150° C.-175° C.), and thermally shrinking the piezoelectric heat shrink tubing on the outer surface of the metal core layer (7) at a transverse scanning rate of 10-15 cm/s within a range of 5-10 cm away from the piezoelectric heat shrink tubing in a seamless tight fitting way, so as to obtain piezoelectric fibers;
step 3: putting the piezoelectric fibers prepared in step 2 into a heating furnace for a heating procedure, and setting the temperature rise rate of the heating furnace to be 1° C.-5° C. per minute to ensure uniform and consistent thermal shrinkage on the whole cross section of the piezoelectric heat shrink tubing;
step 4: after naturally cooling the piezoelectric heat shrink tubing in step 3 to room temperature, uniformly coating the surface of the piezoelectric heat shrink tubing with a conductive film layer as the first conductive layer (5);
step 5: selecting the piezoresistive heat shrink tubing matched with the thermally shrunk piezoelectric heat shrink tubing on the basis of the shrinkage ratio of the piezoresistive heat shrink tubing;
step 6: sleeving the outer side of the first conductive layer (5) with the piezoresistive heat shrink tubing, setting the temperature of the heat gun according to the thermal shrinkage temperature of the piezoresistive heat shrink tubing (the optimal temperature for the crosslinked PA66 heat shrink tubing is usually 80° C.-150° C.), and thermally shrinking the piezoresistive heat shrink tubing on the outer surface of the heat shrink tubing at a transverse scanning rate of 10-15 cm/s within a range of 5-10 cm away from the piezoresistive heat shrink tubing in a seamless tight fitting way, so as to obtain a piezoelectric-piezoresistive heat shrink tubing;
step 7: putting the piezoelectric-piezoresistive heat shrink tubing prepared in step 6 into the heating furnace for the heating procedure, and setting the temperature rise speed of the heating furnace to ensure uniform and consistent thermal shrinkage on the whole cross section of the piezoresistive heat shrink tubing;
step 8: after naturally cooling the piezoresistive heat shrink tubing in step 7 to room temperature, sleeving the piezoresistive heat shrink tubing with the insulating heat shrink tubing, and selecting the insulating heat shrink tubing matched with the thermally shrunk piezoresistive heat shrink tubing on the basis of the shrinkage ratio of the insulating heat shrink tubing;
step 9: sleeving the outer side of the piezoresistive heat shrink tubing with the insulating heat shrink tubing, setting the temperature of the heat gun according to the thermal shrinkage temperature of the insulating heat shrink tubing (the optimal temperature for the EPDM heat shrink tubing is usually 135° C.-150° C.), and thermally shrinking the insulating heat shrink tubing on the outer surface of a piezoresistive layer at a transverse scanning rate of 10-15 cm/s within a range of 5-10 cm away from the insulating heat shrink tubing in a seamless tight fitting way, so as to obtain metal-core piezoelectric-piezoresistive composite fibers;
step 10: putting the metal-core piezoelectric-piezoresistive composite fibers prepared in step

9. into the heating furnace for the heating procedure, and setting the temperature rise speed of the heating furnace to be 1° C.-3° C. per minute to ensure uniform and consistent thermal shrinkage on the whole cross section of the metal-core piezoelectric-piezoresistive composite fibers; and
step 11: after naturally cooling to room temperature, taking out the metal-core piezoelectric-piezoresistive composite fibers in step 10 to finish preparation.

12. A rapid preparation method for preparing the composite fibers with dynamic and static sensing functions based on the thermal shrinkage process according to claim 6, comprising the following steps:
step 1: sleeving the fiber core layer (1) with the piezoresistive heat shrink tubing, selecting the piezoresistive heat shrink tubing matched with the fiber core layer (1) according to the shrinkage ratio of the piezoresistive heat shrink tubing;
step 2: sleeving the outer side of the fiber core layer (1) with the piezoresistive heat shrink tubing, setting the temperature of a heat gun according to the thermal shrinkage temperature of the piezoresistive heat shrink tubing (the optimal temperature for the crosslinked PA66 heat shrink tubing is usually 80° C.-150° C.), and thermally shrinking the piezoresistive heat shrink tubing on the outer surface of the fiber core layer (1) at a transverse scanning rate of 10-15 cm/s in a range of 5-10 cm away from the piezoresistive heat shrink tubing in a seamless tight fitting way;
step 3: putting the piezoresistive heat shrink tubing prepared in step 2 into the heating furnace for a secondary heating procedure, and setting the temperature rise rate of the heating furnace to ensure uniform and consistent thermal shrinkage on the whole cross section of the piezoelectric heat shrink tubing;
step 4: after naturally cooling the piezoresistive heat shrink tubing in step 3 to room temperature, uniformly coating the surface of the piezoresistive heat shrink tubing with a conductive film layer as the second conductive layer (3);
step 5: sleeving the piezoresistive heat shrink tubing processed in step 4 with the piezoelectric heat shrink tubing, and selecting the piezoelectric heat shrink tubing matched with the piezoresistive heat shrink tubing according to the shrinkage ratio of the piezoelectric heat shrink tubing;
step 6: sleeving the outer side of the second conductive layer (3) with the piezoelectric heat shrink tubing, setting the temperature of the heat gun according to the thermal shrinkage temperature of the piezoelectric heat shrink tubing (the optimal temperature for the PVDF heat shrink tubing is usually 150° C.-175° C.), and thermally shrinking the piezoelectric heat shrink tubing on the outer surface of the second conductive layer (3) at the transverse scanning rate of 10-15 cm/s within a range of 5-10 cm away from the piezoelectric heat shrink tubing in a seamless tight fitting way, so as to obtain a piezoresistive-piezoelectric heat shrink tubing;
step 7: putting the piezoresistive-piezoelectric heat shrink tubing prepared in step 6 into the heating furnace for the heating procedure, and setting the temperature rise rate of the heating furnace to be 1° C.-5° C. per minute to ensure uniform and consistent thermal shrinkage on the whole cross section of the piezoresistive-piezoelectric heat shrink tubing;
step 8: after naturally cooling the piezoresistive-piezoelectric heat shrink tubing in step 7 to room temperature, uniformly coating the surface of the piezoresistive-piezoelectric heat shrink tubing with a conductive film layer as the first conductive layer (5);
step 9: sleeving the piezoresistive-piezoelectric heat shrink tubing prepared in step 8 with the insulating heat shrink tubing, and selecting the insulating heat shrink tubing matched with the piezoresistive-piezoelectric heat shrink tubing according to the shrinkage ratio of the insulating heat shrink tubing;
step 10: sleeving the outer side of the piezoresistive-piezoelectric heat shrink tubing with the insulating heat shrink tubing, setting the temperature of the heat gun according to the thermal shrinkage temperature of the insulating heat shrink tubing (the optimal temperature for the EPDM heat shrink tubing is usually 135° C.-150° C.), and thermally shrinking the insulating heat shrink tubing on the outer surface of the first conductive layer (5) at the transverse scanning rate of 10-15 cm/s within a range of 5-10 cm away from the insulating heat shrink tubing in a seamless tight fitting way, so as to obtain nonmetal-core piezoresistive-piezoelectric composite fibers;
step 11: putting the nonmetal-core piezoresistive-piezoelectric composite fibers prepared in step 10 into the heating furnace for the heating procedure, and setting the temperature rise rate of the heating furnace to be 1° C.-3° C. per minute to ensure uniform and consistent thermal shrinkage on the whole cross section of the nonmetal-core piezoresistive-piezoelectric composite fibers; and
step 12: after naturally cooling the nonmetal-core piezoresistive-piezoelectric composite fibers in step 11 to room temperature, taking out the nonmetal-core piezoresistive-piezoelectric composite fibers to finish preparation.
